(19) United States
(12) Patent Application Publication
(10) Pub. No.: US 2006/0002562 A1
(43) Pub. Date: Jan. 5, 2006

(54) Method and apparatus for geometric key establishment protocols based on topological groups

(76) Inventors: Arkady Berenstein, Eugene, OR (US); Leon Chernyak, Brighton, MA (US)

Correspondence Address: LEON CHERNYAK, 112 ACADEMY HILL RD. #1, BRIGHTON, MA, 02135, US

(21) Appl. No.: 10/708,197

(22) Filed: Feb. 16, 2004

Related U.S. Application Data
(60) Provisional application No. 60/319,966, filed on Jun. 2, 2003.

(51) Int. Cl. H04L 9/00

(52) U.S. Cl. 380/278

(57) ABSTRACT

The present invention proposes a continuous multi-parameter version of Diffie-Hellman protocol based on topological groups. In its turn, based on this continuous protocol, a method for public establishment and distribution of keys for encryption systems is implemented. An embodiment of the method, while providing an extremely high security level, is several orders of magnitude faster than the existing key establishment systems.

### CROSS REFERENCE TO RELATED APPLICATIONS

U.S. Pat. No. 5,696,826, December/1997, by Gao; U.S. Pat. No. 6,493,449, December/2002, Anshel et al; U.S. patent application Ser. No. 10/605,935, November/2003, Berenstein and Chernyak.

### BACKGROUND OF INVENTION

Description of the Prior Art: Key Establishment Protocols

The concepts, terminology and framework for understanding cryptographic key establishment protocols is given in Alfred J. Menezes, Paul C. van Oorschot, and Scott A. Vanstone, “Handbook of Applied Cryptography,” CRC Press (1997), pages 490-491.

A ‘protocol ’ is a multi-party algorithm, defined by a sequence of steps specifying the actions required of two or more parties in order to achieve a specified objective.

A ‘key establishment’ protocol is a protocol whereby a shared secret becomes available to two or more parties, for subsequent cryptographic applications.

A ‘key transport’ protocol is a key establishment protocol where one party creates or obtains a secret value, and securely transfers it to the other participating parties.

A ‘key agreement’ protocol is a key establishment protocol in which a shared secret is derived by two (or more) parties as a function of information contributed by, or associated with, each of the participating parties such that no party can predetermine the resulting value.

A ‘key distribution ’ protocol is a key establishment protocol whereby the established keys are completely determined a priori by initial keying material.

The Diffie-Hellman key establishment protocol (also called ‘exponential key exchange’) is a fundamental algebraic protocol. It is presented in W. Diffie and M. E. Hellman, “New Directions in Cryptography,” IEEE Transaction on Information Theory vol. IT 22 (November 1976), pp. 644-654. The Diffie-Hellman protocol provided the first practical solution to the key distribution problem, allowing two parties, never having met in advance or sharing keying material, to establish a shared secret by exchanging messages over an open channel.

The security of this protocol rests on the intractability of the Diffie-Hellman problem and the related problem of computing discrete logarithms in the multiplicative group of the finite field GF(p) where p is a large prime, cf. Alfred J. Menezes, Paul C. van Oorschot, and Scott A. Vanstone, “Handbook of Applied Cryptography,” CRC Press (1997), page 113.

Most of known applications of Diffie-Hellman protocol deal with finite groups. Recently there emerged versions of Diffie-Hellman protocol for infinite, but yet discrete groups (see for example, U.S. Pat. No. 6,493,449 by Anshel et al).

Unlike approaches existing in the prior art, the present invention is based not on finite or discrete groups, but rather on the connected compact topological groups.

Brief overview of connected compact topological groups

The basic reference for concepts, terminology and historical framework in topological group are given in the monograph by Philip J Higgins, Introduction to topological groups, Cambridge: University Press, 1974, and in the monograph by John F. Price, Lie groups and compact groups, Cambridge [Eng]; New York: Cambridge University Press, 1977.

A group (G,*) is defined as a set G together with a binary operation *: G×G→G satisfying the following axioms:

Associativity: For all a, b and c in G, (a*b)*C=a*(b*c).

Identity element: There is an element e in G such that for all a in G, e*a=a=a*e.

Inverse element: For all a in G, there is an element b in G such that a*b=e=b*a, where e is the identity element from the previous axiom.

A topological group G is a group which is also a topological space such that the group multiplication G×G→G and the operation of taking inverses G→G are continuous maps. (Here, G×G is viewed as a topological space by using the product topology).

A topological group G is called compact if the underlying topological space is compact, i.e., if any open cover of the space G has a finite sub-cover.

A first example of compact topological groups is any finite group (equipped with the discrete topology). Such groups provide examples of compact disconnected topological groups.

Another class of compact topological groups is connected compact topological groups. A topological group is connected if the underlying topological space is connected. This class contains such groups as SO(V), where SO(V) is the group of all special orthogonal transformations of a Euclidean vector space V (therefore, there are at least as many compact connected topological groups as there are Euclidean vector spaces).

The present invention implements the ideas and algorithms of Diffie-Hellman protocol for the case of connected compact topological groups. This approach allows one to bypass and, in some cases, to completely eliminate the computational complexity of the exponentiation operation. Such an approach does not exist in the prior art.

### SUMMARY OF INVENTION

Geometric key establishment system of the present invention allows for easy, secure, and rapid creation and distribution of encryption/decryption keys for major cryptosystems. The procedures of creation and distribution of keys are performed extremely rapidly and have very low computer memory requirements.

The present invention proposes a continuous version of Diffie-Hellman protocol. Based on this continuous Diffie-Hellman protocol, a method for public distribution of keys for encryption/decryption systems is implemented. An embodiment of the method, while providing an extremely high security level, is several orders of magnitude faster than existing key distribution systems.

The key creation process of the system hereof uses the operation of linear combination with integer coefficients of irrational numbers and the operation of taking fractional parts of real numbers. In more advanced implementations the operation of taking fractional parts can be replaced by the exponentiation from the compact Lie algebra into the corresponding compact Lie group.

The system of the present invention constructs encryption/decryption keys on the fly out of a publicly chosen n-tuple g of irrational numbers and a pair of secret integer n×n matrices A and B, where the first integer matrix A is generated by the first communicating party and the second integer matrix B—by the second, and the matrices commute, i.e., A·B=B·A. Absolute values of matrix coefficients of these matrices are bounded by a publicly available constant 10^{N} that may be arbitrarily big. Thus the keys created and distributed by the system hereof can be of any given in advance size. The present invention combines the idea of Diffie-Hellman protocol of key distribution with the idea of the geometric cryptosystem developed in the U.S. patent application Ser. No. 10/605,935 entitled GEOMETRY-BASED SYMMETRIC CRYPTOSYSTEM METHOD by the authors Arkady Berenstein and Leon Chernyak.

The security of the system of the present invention is based on the following well-known paradigm from Number Theory. Let β₁, β₂, . . . be a sequence of irrational numbers (or more generally, of irrational elements of a compact Lie group) and let γ be an irrational number computed with the precision of K decimal places. Then any algorithm that recognizes γ as an element of the sequence β₁, β₂, . . . and identifies the index n such that γ=βₙ n must work at least C·10^{K} units of time where C is an a priori given constant.

### BRIEF DESCRIPTION OF DRAWINGS

FIG. 1 is a block diagram of the mathematical apparatus that can be used in practicing embodiments of the invention.

FIG. 2 is a flow diagram of the geometric key establishment system which shows generation of commuting matrices with integer coefficients; when taken with the subsidiary flow diagrams referred to therein, can be used in implementing embodiments of the invention.

FIG. 3 is a flow diagram of the geometric key establishment system which shows the exponentiation of n-tuples of group elements into matrix powers; when taken with the subsidiary flow diagrams referred to therein, can be used in implementing embodiments of the invention.

FIG. 4 is a flow diagram of the geometric key establishment system which shows the fractional multiplication of n-tuples of real numbers by integer n×n matrices; when taken with the subsidiary flow diagrams referred to therein, can be used in implementing embodiments of the invention.

FIG. 5 is a block diagram of the geometric key establishment system that can be used in practicing n-dimensional embodiments of the invention.

FIG. 6 is a block diagram of the geometric key establishment system that can be used in practicing one-dimensional embodiments of the invention.

FIG. 7 is a block diagram of the geometric key establishment system that can be used in practicing preferred n-dimensional embodiments of the invention in the case when the group operation consists of taking the fractional part of sum of real numbers.

geometric key establishment system the is a block diagram of FIG. 8 that can be used in practicing preferred one-dimensional embodiments of the invention in the case when the group operation consists of taking the fractional part of sum of real numbers.

### DETAILED DESCRIPTION

The key creation and distribution techniques of an embodiment of the geometric key establishment system hereof are based on the operation of multiplication of real numbers by integers and the operation of evaluating fractional parts of real numbers. More specifically, the n-dimensional embodiment of the system hereof is based on the operation of multiplication of real vectors by integer matrices and on the operation of evaluating fractional parts of coordinates of the vectors.

In more advanced implementations the operation of evaluating fractional parts can be replaced by the exponentiation from the compact Lie algebra into the corresponding compact Lie group.

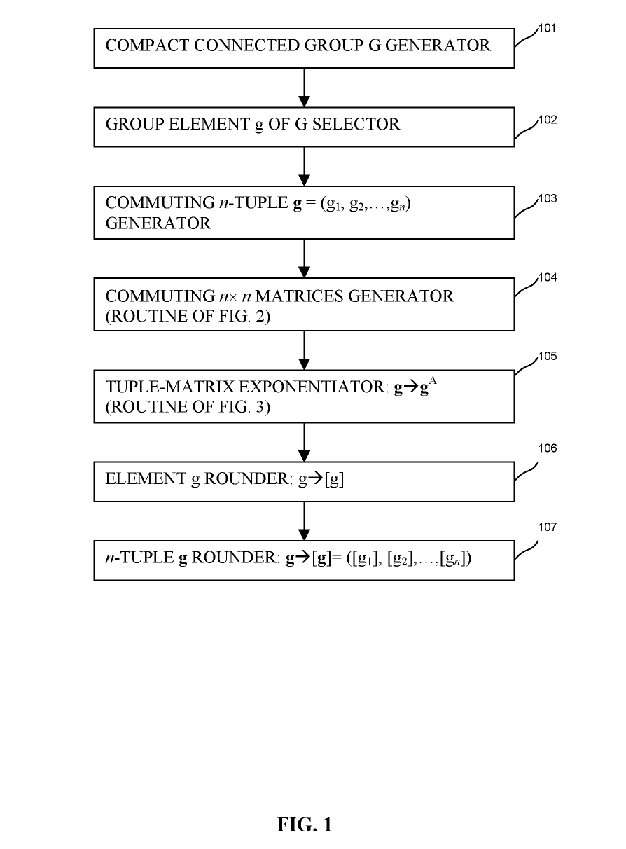

A preferred exemplary embodiment of such an apparatus is depicted with block diagram in FIG. 1, and is described as follows.

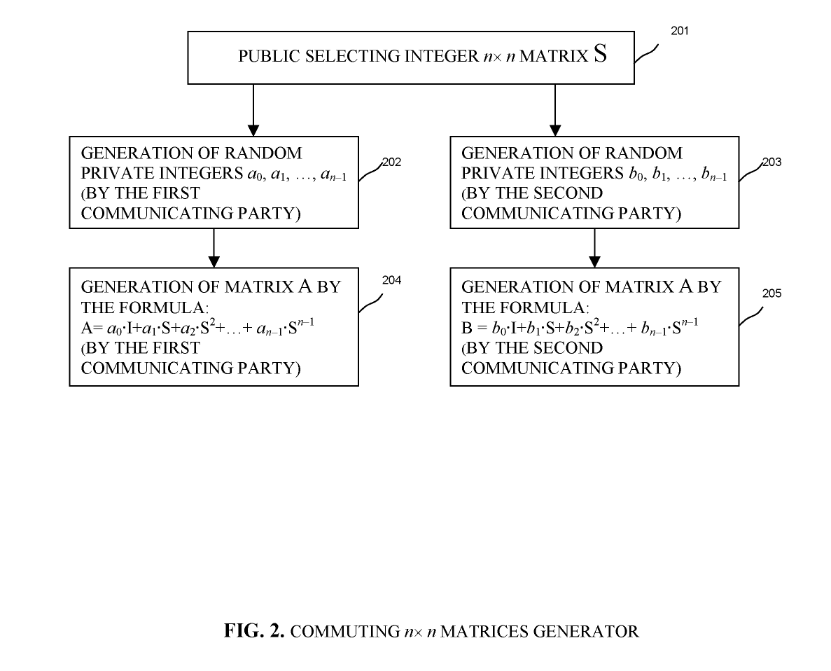

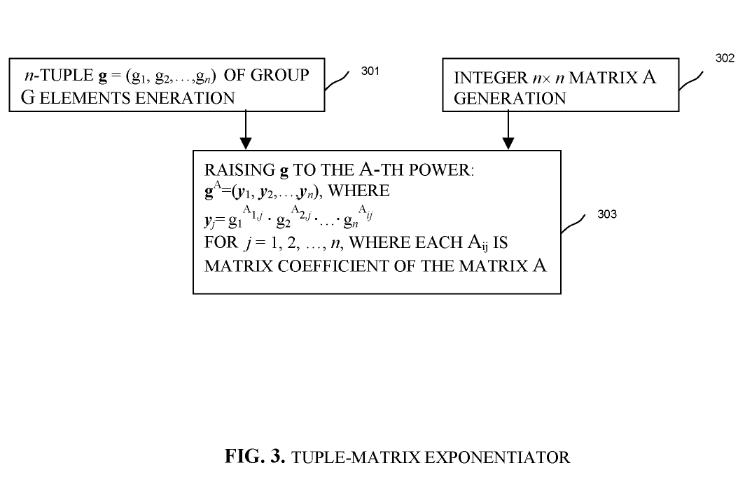

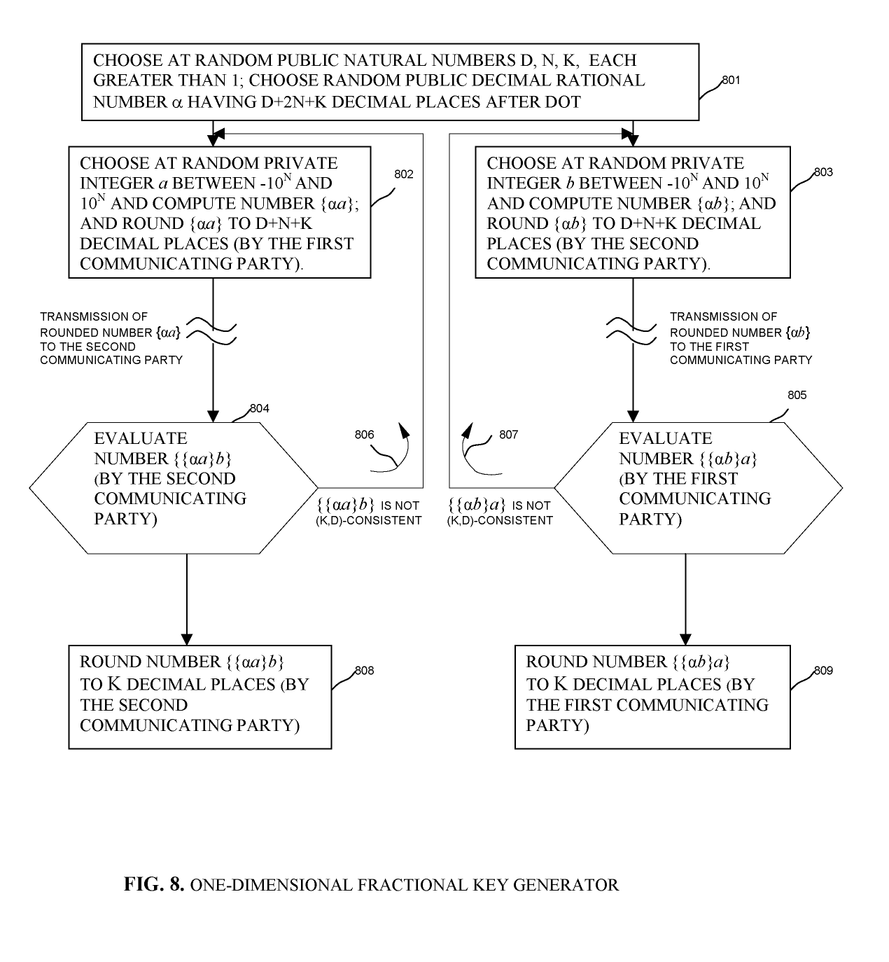

Let G be a compact connected group whose law of composition
G×G→G
is feasibly computable. There are among such groups the special orthogonal group, the unitary group and their closed connected subgroups. The block 101 generates such groups. Since each such group has uncountably many elements, the block 102 selects an element g of G essentially at random. The block 103 generates a n-tuple g=(g₁,g₂, . . . , gₙ) of pairwise commuting elements g₁, g₂, . . . , gₙ of G. This generator may proceed by choosing a commutative subgroup of G and then selecting elements g₁, g₂, . . . ,gₙ from this subgroup. Alternatively, the group generator 101 can start with choosing a commutative group G. The block 104 is designed for independent generation of commuting integer matrices, which procedure is depicted in more details in FIG. 2. The block 105 is designed for raising each n-tuple g=(g₁, g₂, . . . , gₙ) into an integer matrix power, which procedure is depicted in more details in FIG. 3. The block 106 rounds each element g of the group G to the nearest element [g] of G. This procedure is depicted in more details in subsequent flow diagrams of FIG. 7 and FIG. 8, where, as a preferred embodiment of the invention hereof, the group operation of G consists of taking the fractional part of sum of real numbers. The block 107 applies the procedure of rounding of the block 106 to each coordinate of a given n-tuple g=(g₁, g₂, . . . , gₙ).

FIG. 2 illustrates a basic procedure of generation of commuting n×n matrices A and B independently by the first and the second communicating parties.

In the block 201 a public n×n matrix S is selected.

In the block 202 the first communicating party chooses at random secret integers a₀, a₁, . . . , aₙ₋₁, and in the block 204 creates a matrix A according to the formula:
A=a₀·I+a₁·S+a₂·S²+ . . . +aₙ₋₁·Sⁿ⁻¹.

In a similar manner and independently, in the block 203 the second communicating party chooses at random secret integers b₀, b₁, . . . , bₙ₋₁, and in the block 205 creates a matrix B according to the formula:
B=b₀·I+b₁·S+b₂·S²+ . . . +bₙ₋₁·Sⁿ⁻¹.

By the design, the matrices A and B commute: A·B=B·A.

FIG. 3 represents a basic procedure of raising a n-tuple g into the A-th power, where A is an n×n matrix.

In the block 301 an n-tuple g=(g₁, g₂, . . . , gₙ) of elements of the group G is generated.

Independently, in the block 302 an n×n matrix A is generated.

And, in the block 303 the power g^{A} is computed according to the formula:
g^{A}=(y₁, y₂, . . . , yₙ),
where
yⱼ=g₁^{A1,j}·g₂^{A2,j}· . . . ·gₙ^{An,j}
for j=1, 2, . . . , n, where Aᵢⱼ is the (i,j)-th matrix coefficient of A.

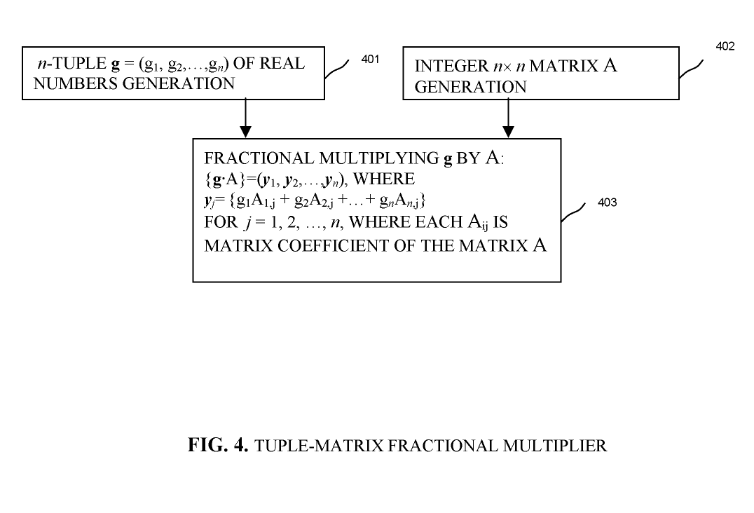

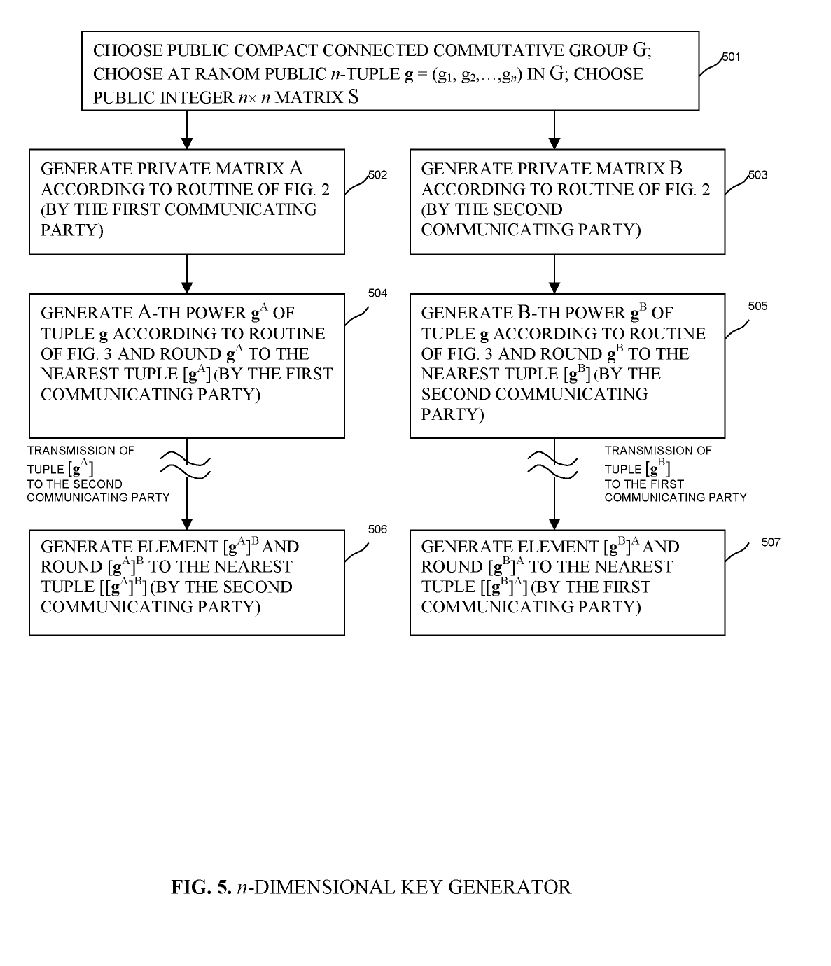

FIG. 4 represents a basic procedure of implementing the routine of FIG. 3 in the case when the group operation consists of taking the fractional part of sum of real numbers.

In the block 401 an n-dimensional real vector g=(g₁, g₂, . . . , gₙ) is generated.

Independently, in the block 402 an n×n matrix A is generated.

And, in the block 403 the fractional product {g·A} is computed according to the formula:
{g·A}=(y₁, y₂, . . . , yₙ),
where
yⱼ={g₁A_{1,j}+g₂A_{2,j}+ . . . +gₙA_{n,j}}
for j=1, 2, . . . , n, where Aᵢⱼ is the (i,j)-th matrix coefficient of A, and where {z} stands for the fractional part of the real number z (for example, {1.7}=0.7, {−1.7}=0.3).

FIG. 5 illustrates creation, establishment, and distribution of a geometric key in an n-dimensional embodiment of the system of the present invention. It refers to the routines illustrated by other referenced flow diagrams (FIG. 1, FIG. 2, FIG. 3) which describe features in accordance with an embodiment of the invention.

The block 501 represents generation of the public compact connected commutative topological group G and a choosing at random a public n-tuple g=(g₁, g₂, . . . , gₙ) of elements of G. A public n×n matrix S is also chosen in this block. Both, g and S are to be used by both communicating parties.

The block 502 represents the routine that can be used by the first communicating party for generating a private matrix A according to the routine of FIG. 2.

Similarly, the block 503 represents the routine that can be used by the second communicating party for generating a private matrix B according to the routine of FIG. 2.

The block 504 represents computation (by the first communicating party) of the n-tuple g^{A} according to the routine of FIG. 3, and rounding g^{A} to the nearest n-tuple [g]. The rounded n-tuple [g^{A}] is then transmitted over an open (public) channel to the second communicating party.

Similarly, the block 505 represents computation (by the first communicating party) of the n-tuple g^{B} according to the routine of FIG. 3, and rounding g^{B} to the nearest n-tuple [g^{B}]. The rounded n-tuple [g^{B}] is then transmitted over an open (public) channel to the first communicating party.

The block 506 represents the routine that can be used by the second communicating party for generating the n-tuple [g^{A}]^{B} (according to the routine of FIG. 3) and rounding it to the nearest n-tuple [[g^{A}]^{B}].

Similarly, the block 507 represents the routine that can be used by the first communicating party for generating the n-tuple [g^{B}]^{A} (according to the routine of FIG. 3) and rounding it to the nearest n-tuple [[g^{B}]^{A}].

By the design, the n-tuples [[g^{A}]^{B}] and [[g^{B}]^{A}] are equal, and thus comprise the common secret geometric key in possession of both communicating parties.

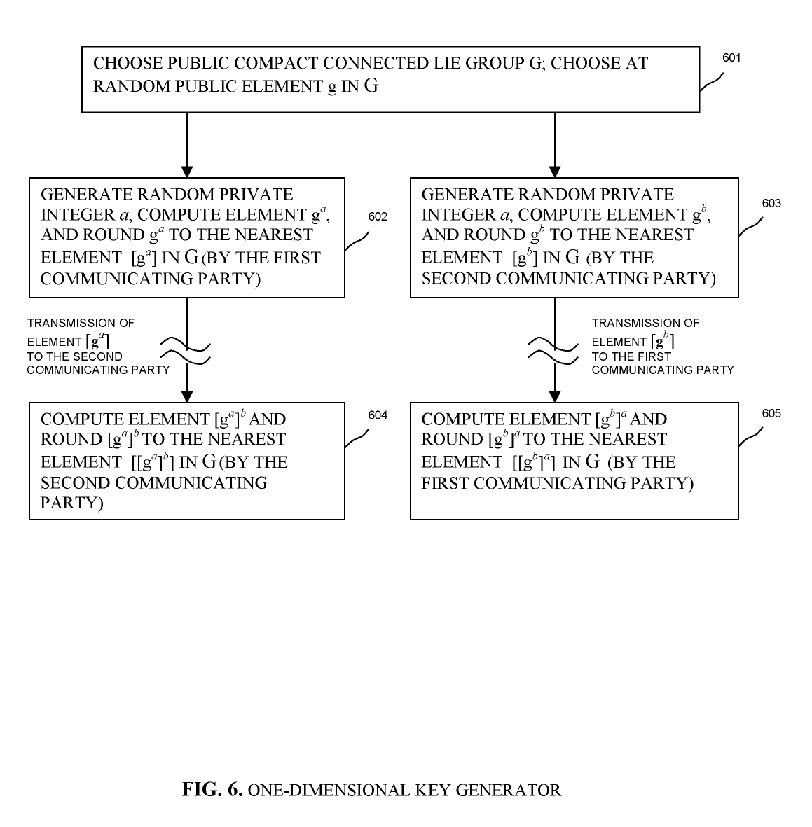

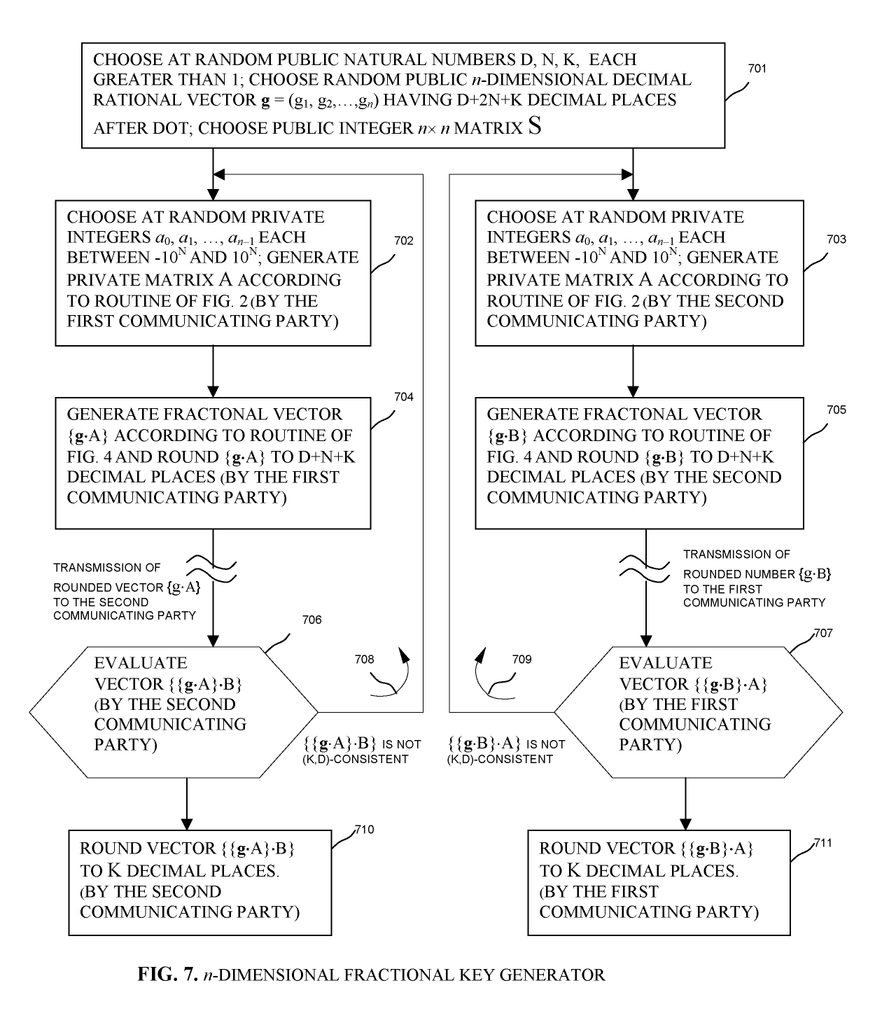

FIG. 6 illustrates creation, establishment, and distribution of a geometric key in a one-dimensional embodiment of the system of the present invention. It refers to the routines illustrated by other referenced flow diagrams which describe features in accordance with an embodiment of the invention.

The block 601 represents generation of the public compact connected topological group G and a choosing at random a public element g of G, which g is to be used by both communicating parties.

The block 602 represents the routine that can be used by the first communicating party for generating a private integer a, computing the a-th power g^{a} of g, and rounding g^{a} to the nearest element [g^{a}] in G. This rounded element [g^{a}] is then transmitted over an open (public) channel to the second communicating party.

Similarly, the block 603 represents the routine that can be used by the second communicating party for generating a private integer b, computing the b-th power g^{b} of g, and rounding g^{b} to the nearest element [g^{b}] in G. This rounded element [g^{b}] is then transmitted over an open (public) channel to the second communicating party.

The block 604 represents the routine that can be used by the second communicating party for generating the element [g^{a}]^{b} and rounding it to the nearest element [[g^{a}]^{b}].

Similarly, the block 605 represents the routine that can be used by the first communicating party for generating the element [g^{b}]^{a} and rounding it to the nearest element [[g^{b}]^{a}]

By the design, the elements [g^{a}]^{b} and [g^{b}]^{a} are equal in G, and thus comprise the common secret geometric key in possession of both communicating parties.

FIG. 7 represents creation, establishment, and distribution of a key in an embodiment of the geometric key establishment system of present invention.

First, public natural numbers D, N, K are generated in the block 701. Next, a public n-dimensional decimal vector g=(g₁, g₂, . . . , gₙ) having D+2N+K after dot is generated in the same block 701. And an integer n×n matrix S is chosen.

Then in the block 702 private integers a₀, a₁, . . . , aₙ₁ (each between −10^{N} and 10^{N}) are generated at random; next, a private matrix A is generated according to routine of FIG. 2.

In a similar manner, in the block 703 private integers b₀, b₁, . . . , bₙ₁ (each between −10^{N} and 10^{N}) are generated at random; next, a private matrix B is generated according to routine of FIG. 2.

In the block 704 the fractional vector {g●A} is computed according to the routine of FIG. 4. Next, each coordinate of the resulted vector is rounded to D+N+K decimal places. The rounded fractional vector {g●A}is then transmitted to the second communicating party.

In a similar manner, in the block 705 the fractional vector {g●B} is computed according to the routine of FIG. 4. First, the vector g is multiplied by the matrix B. Next, each coordinate of the resulted vector is rounded to D+N+K decimal places. The rounded fractional vector {g●B} is then transmitted to the second communicating party.

The block 706 represents the routine that can be used by the second communicating party for computing the fractional vector {{g●A}●B}. The loop 708 is used in the case when the vector {{g●A}●B} is not (K,D)-consistent (that is, in the case when the sequence of the digits d_{K+1}, d_{K+2}, . . . d_{K+D} of at least one coordinate of the vector {{g●A}●B} is either 0, 0, . . . , 0 or 9, 9, . . . , 9.) The loop 708 is continued until the vector {{g●A}●B} becomes (K,D)-consistent. [The probability of a vector {{g●A}●B} to be not (K,D)-consistent is extremely low. Namely, this probability is measured as at most 1−(1−2·10^{-D})ⁿ. The probability of the need for the second run of the loop 708 is measured as at most (1−(1−2·10^{-D})ⁿ)²]. The block 710 is then entered, this block represents the generation of a vector γ which is the rounding of the (K, D)-consistent vector {{g●A}●B} to K decimal places.

In a similar manner the block 707 represents the routine that can be used by the first communicating party for computing the fractional vector {{g●B}●A}. The loop 709 is used in the case when the vector {{g●B}●A} is not (K,D)-consistent (that is, in the case when the sequence of the digits d_{K+1}, d_{K+2}, . . . d_{K+D} of at least one coordinate of the vector {{g●B}●A} is either 0, 0, . . . , 0 or 9, 9, . . . , 9.) The loop 709 is continued until the vector {{g●B}●A} becomes (K,D)-consistent. [The probability of a vector {{g●B}●A} to be not (K,D)-consistent is extremely low. Namely, this probability is measured as at most 1−(1−2·10^{-D})ⁿ. The probability of the need for the second run of the loop 709 is measured as at most (1−(1−2·10^{-D})ⁿ)²]. The block 711 is then entered, this block represents the generation of a vector γ′ which is the rounding of the (K, D)-consistent vector {{g●B}●A} to K decimal places.

By the design, the vectors γ and γ′ are equal, and thus comprise the common secret key in possession of both communicating parties.

FIG. 8 represents creation, establishment, and distribution of a key in an embodiment of the geometric key establishment system of present invention.

First, a public real number α and public natural numbers D, N, K are generated in the block 801.

Then in the block 802 a private integer a (between −10^{N} and 10^{N}) is generated at random, and the number {αa} is computed and rounded to D+N+K decimal places by the first communicating party. The rounded number {αa} is then transmitted to the second communicating party.

In a similar manner, in the block 803 a private integer b (between −10^{N} and 10^{N}) is generated at random, and the number {αb} is computed and rounded to D+N+K decimal places by the second communicating party. The rounded number {αb} is then transmitted to the first communicating party.

The block 804 represents the routine that can be used by the second communicating party for computing the number {{αa}b}. The loop 806 is used in the case when the number {{αa}b} is not (K, D)-consistent (that is, in the case when the sequence of the digits d_{K+1}, d_{K+2}, . . . , d_{K+D} of the number {{αa}b} is either 0, 0, . . . , 0 or 9, 9, . . . , 9). The loop 806 is continued until the number {{αa}b} becomes (K, D)-consistent. [The probability of a number {{αa}b} to be not (K,D)-consistent is extremely low. Namely, this probability is measured as at most 2·10^{-D}. The probability of the need for the second run of the loop 806 is measured as at most (2·10^{-D})²]. The block 808 is then entered, this block represents the generation of a number γ which is the rounding of the (K, D)-consistent number {{αa}b} to K decimal places.

In a similar manner block 805 represents the routine that can be used by the first communicating party for computing the number {{αb}a}. The loop 807 is used in the case when the number {{αb}a} is not (K,D)-consistent (that is, in the case when the sequence of the digits d_{K+1}, d_{K+2}, . . . , d_{K+D} of the number {{αb}a} is either 0, 0, . . . , 0 or 9, 9, . . . , 9). The loop 805 is continued until the number {{αa}b} becomes (K,D)-consistent. [The probability of a number {{αb} a} to be not (K,D)-consistent is extremely low. Namely, this probability is measured as at most 2·10^{-D}. The probability of the need for the second run of the loop 807 is measured as at most (2·10^{-D})²]. The block 809 is then entered, this block represents the generation of a number γ′ which is the rounding of the (K,D)-consistent number {{αb}a} to K decimal places.

By the design, the numbers γ and γ′ are equal, and thus comprise the common secret key in possession of both communicating parties.

The security of the system of the present invention comes from the built-in geometric density of certain sequences of irrational numbers in the semi-open interval [0, 1) of the real line. In other words, security of the proposed system is guaranteed by the obvious mathematical fact that there is no any a priori known general distribution pattern for members of certain sequences of irrational numbers.

More precisely, let β₂, β₂, . . . be a sequence of irrational numbers (or more generally, of irrational elements of a compact Lie group) and let γ be an irrational number computed with the precision of K decimal places. Then any algorithm that recognizes γ as an element of the sequence β₁, β₂, . . . and identifies the index n such that γ=βₙ must work at least C·10^{K} units of time where C is an a priori given constant.

Apparently, approaches that are the closest to the present invention are developed in U.S. Pat. No. 5,696,826 entitled METHOD AND APPARATUS FOR ENCRYPTING AND DECRYPTING INFORMATION USING A DIGITAL CHAOS SIGNAL by Gao, in U.S. Pat. No. 6,493,449 entitled METHOD AND APPARATUS FOR CRYPTOGRAPHICALLY SECURE ALGEBRAIC KEY ESTABLISHMENT PROTOCOLS BASED ON MONOIDS by Anshel et al, and in U.S. patent application Ser. No. 10/605,935 entitled GEOMETRY-BASED SYMMETRIC CRYPTOSYSTEM METHOD by Berenstein and Chernyak.

The idea of using fractional parts of multiples of given irrational numbers is not new in cryptography. This idea is used to obtain a uniform distribution of numbers in the unit interval. It was used, for example, in the patent by Gao. However, this is perhaps the only similarity between these previous works and the system of the present invention. In the system hereof, fractional parts of multiples of given irrational numbers are never used for obtaining a uniform distribution of numbers, but rather for creation of a deterministic (non-random) keys.

The idea of using infinite groups for key establishment an exchange is relatively new. It is presented in the patent by Anshel et al. However, the present invention is the first where continuous, topological groups are used for key establishment and exchange. In patent application by Berenstein and Chernyak the geometric continuity is utilized for constructing private encryption systems.

An embodiment of the system hereof deals with a publicly chosen real number α and a pair of secret integers a and b, where the first integer a is generated by the first communicating party and the second integer b—by the second communicating party. Absolute value of each of these integers is bounded by a publicly available constant 10^{N} that may be arbitrarily big. Thus the keys created and distributed by the system hereof can be of any given in advance size. The present invention combines the idea of Diffie-Hellman protocol of key establishment with the idea of the geometric cryptosystem developed in the patent application Ser. No. 10/605,935 by the authors Arkady Berenstein and Leon Chernyak.

In this embodiment the real number α can be chosen essentially at random from the infinite set of known real numbers. This choice can include such numbers as, for example, √m, where m is any natural number that is not a complete square, or, more generally, α can be any irrational real root of an algebraic equation with integer coefficients. Also α can be chosen, for example, as πⁿ or eⁿ, where n is any natural number, or, more generally, α can be any polynomial with integer coefficients evaluated at a given transcendental number. Another possible source of irrational numbers may include, for example, sin(n), cos( ), In(n), where n is any natural number; or, more generally, α (can be any transcendental function evaluated at a given natural number.

Let {x} be the fractional part of a real number x. By definition, for each real number x, the fractional part {x} is given by:
{x}=x−[x],
where [x]is the integer part of x, that is, [x]is the greatest integer that is less or equal x. If the numbers a and b are integers having at most N decimal digits each (that is, |a|<10^{N} and |b|<10^{N}) and each of the numbers {αa} and {αb} is rounded to D+N+K decimal places after dot (where D, N, and K are natural numbers each greater than 1), then the created and distributed key, which is {αab}, will have K correct decimal places after the dot. These K correct digits serve as the encryption/decryption key of major cryptosystems.

The security of the system of the present invention is based on the following well-known paradigm from Number Theory. Let β₁, β₂, . . . be a sequence of irrational numbers (or more generally, of irrational elements of a compact Lie group) and let γ be an irrational number computed with the precision of K decimal places. Then any algorithm that recognizes γ as an element of the sequence β₁, β₂, . . . and identifies the index n such that γ=βₙ must work at least C·10^{K} units of time where C is an a priori given constant.

In particular, the security of the system hereof is based on the fact that there cannot be any a priori known general distribution pattern of fractional parts of multiples of each taken at random irrational number α. Therefore, the security level of the system hereof can be measured as a number of operations needed for reconstruction of the number a out of a given fractional number {αa} calculated with the precision of D+N+K decimal places. The above implies that the only way to reconstruct the number a out of a given fractional number {αa} is to list all possible numbers {αL}, where L is any integer between −10^{N} and 10^{N}. The number of such numbers L is 2·10^{N}−1.

For a cryptanalyst, the only alternative to listing all possible numbers a is to list all possible shared K-digits keys. The number of such keys is 10^{K}. Therefore, the security level of the system hereof can be measured as the minimum of the two numbers 2·10^{N}−1 and 10^{K}.

The processor time required for creation and distribution of one geometric key is at most quadratic in N and K, or, more precisely, is at most N(2D+3N+2K) units of processor time. This speed is several orders of magnitude higher than in existing key establishment systems.

In creating geometric key establishment system in accordance with an embodiment hereof, a first step is to choose publicly available parameters of the system: a real number α and natural numbers D, N, K, each greater than 1, where D stand for the size of the error control buffer, N stands for the maximum number of decimal places in each secret parameter a and b, and K stands for the key length.

An embodiment of the geometric key establishment system hereof relies on the concept of (K, D)-consistent numbers. An infinite decimal fraction δ=0. d₁ d₂ d₃ . . . is said to be (K, D)-consistent if the sequence of the digits d_{K+1}, d_{K+2}, . . . , d_{K+D} is neither 0, 0, . . . , 0 nor 9, 9, . . . , 9.

To implement the key creation and key distribution of this example, the first communicating party, call it Alice, chooses a secret integer a between −10^{N} and 10^{N} (i.e., a has at most N decimal places), calculates the number β, which is the fractional part {αa} rounded to D+N+K decimal places, and sends so calculated rounding β of {αa} to the second the first communicating party, call it Bob. [It is assumed in this example that Alice and Bob share the publicly available parameters α and D, N, K]. Simultaneously and independently Bob chooses a secret integer b between −10^{N} and 10^{N} (i.e., b has at most N decimal places), calculates the number β′, which is the fractional part {αb} rounded to D+N+K decimal places, and sends so calculated rounding β′ of {αb} to Alice. Upon receiving β from Alice, Bob multiplies β by b, computes the fractional part {βb} with the precision of K+D decimal places after the dot. If {βb} is (K, D)-consistent, Bob computes the number γ that is the rounding of {βb} to the K digits after the decimal dot. This number γ is the geometric key in possession of Bob. Upon receiving β′ from Bob, Alice multiplies β′ by a, computes the fractional part {β′a} with the precision of K+D decimal places after the dot. If {β′a} is (K, D)-consistent, Alice computes the number γ′ that is the rounding of {β′a} to the K digits after the decimal dot. Then Alice computes the number γ′ that is the rounding of {β′a} to the K digits after the decimal dot. This number γ′ is the geometric key in possession of Alice. In this case (which is the general case), the geometric key γ is equal to the geometric key γ′. In those (extremely rare) cases when {βb} is not (K, D)-consistent, the geometric key has to be redistributed because otherwise it may happen that γ≠γ′. In order to avoid such a situation, Alice and Bob choose new secret numbers a₁ and b₁ respectively (while keeping the same α and D, N, K) and repeat the above steps until they get a new geometric key γ₁=γ′₁ (provided that the new number {β₁ b₁} is (K, D)-consistent).

The probability of the need for such redistribution is extremely low and is measured as at most 2·10^{-D}. The probability of the need for the second key distribution is measured as at most (2·10^{-D})².

The embodiment of the system hereof is based on the following mathematical argument.

The definition of the fractional part {x} of x implies that {x} always belongs to the semi-open interval [0, 1), and that
{x+c}={x}
for any integer c. In its turn this implies that
{{x}d}={xd}
for any integer d. Therefore,
{{αa}b}={αab}={αba}={{αb}a}.

Since −10^{N}<a<10^{N}, and −10^{N}<b<10^{N}; and both {αa} and {αb} are computed with D+N+K correct decimal places after dot, it is asserted that the left hand side {{αa}b} and the right hand side {{αb}a} are equal in the first K decimal places after dot if {αa} and {αb} are both (K, D)-consistent. In order to prove the assertion, the following notation is introduced. Let {αa} be rounded to D+N+K correct decimal places, i.e., to the number
β={αa}+θ·10^{-(D+N+K)},
where |θ|<0.5, and let {αb} be also rounded to N+D+K correct decimal places, i.e., to the number
β′={αb}+θ′·10^{-(D+N+K)},
where |θ′|<0.5. Then {{αa}b} is calculated as {βb} and {{αb}a} is calculated as {β′b}. Furthermore,

$$\{ β b \} = \{ ( \{ α a \} + θ \cdot {10}^{- ( D + N + K )} ) b \} = \{ \{ α a \} b + θ \cdot {10}^{- ( D + N + K )} \cdot b \} = \\ = \{ \{ α a \} b + θ \cdot {10}^{- D - K} \} = \{ \{ \{ α a \} b \} + {θ}_{1} \cdot {10}^{- D - K} \} = \{ \{ α ab \} + {θ}_{1} \cdot {10}^{- D - K} \} ,$$

where θ₁ is some number such that |θ₁|<0.5.

Similarly

$$\{ {β}^{′} a \} = \{ ( \{ α b \} + {θ}^{′} \cdot {10}^{- ( D + N + K )} \} a \} = \{ \{ α b \} a + {θ}^{′} \cdot {10}^{- ( D + N + K )} \cdot a \} = \\ = \{ \{ α b \} a + {θ}_{1}^{′} \cdot {10}^{- D - K} \} = \{ \{ \{ α b \} a \} + {θ}_{1}^{′} \cdot {10}^{- D - K} \} = \{ \{ α ba \} + {θ}_{1}^{′} \cdot {10}^{- D - K} \} ,$$

where θ′₁ is some number such that |θ′₁|<0.5.

Let γ be the rounding of {βb} to K decimal places after dot and let γ′ be rounding of {β′a} to K decimal places after dot. The above calculation of {βb} and {β′a} ensures that, if γ≠γ′, then necessarily one of these numbers, say {βb}, has all digits equal 9 at each i-th decimal place after dot, when i=K+1, K+2 . . . ., K+D, and, at the same time, the second of these numbers, i.e., {β′a}, has digits equal 0 at each i-th decimal place after dot, when i=K+1, K+2, . . . , K+D. In other words, γ≠γ′ implies that both {βb} and {β′a} are not (K, D)-consistent. Therefore, if {βb} is (K, D)-consistent, γ=γ′. Similarly, γ=γ′ if {β′a} is (K, D)-consistent. This proves the assertion.

In creating geometric key establishment system in accordance with an embodiment hereof (and with the following small numbers for ease of illustration), a first step is to choose publicly available parameters of the system: an real number α and integer parameters D, N, K greater than 1 each. Take, for example, α=√2, N=K=8, D=2. Next, suppose that Alice chooses the number a=48 176 925. Alice calculates the number {αa} with the precision D+N+K=18 by β={αa}={√2·48 176 925}=0.728431422183990298 and sends this number β to Bob. Suppose that at the same time Bob chooses the number b=19082791. Bob calculates the number {αb} with the precision D+N+K=18 by β′={αb}={√2·19082791}=0.840131236839417426 and sends this number β′ to Alice. Upon receiving the number from β Alice, Bob multiplies β by b, computes the fractional part {βb} with the precision K+D=10 decimal places after dot:
{βb}={0.728431422183990298·19082791}=0.5873698504.

Since this number is (K, D)-consistent, i.e., it has digits 0 and 4 at 9^{th} and 10^{th} places after dot, the first K=8 digits of this number is the geometric key in possession of Bob:
γ=0.58736985.

Upon receiving the number β′ from Bob, Alice multiplies β′ by a, computes the fractional part {β′a} with the precision K+D=10 decimal places after dot:
{βa}={0.84013123683941742596·48 176 925}=0.5873698504.

Since this number is (K, D)-consistent, i.e., it has digits 0 and 4 at 9^{th} and 10^{th} places after dot, the first K=8 digits of this number is the geometric key in possession of Alice:
γ′=0.58736985.

Thus, γ=γ′ is the geometric key shared by Alice and Bob. This key can be used in any major symmetric cryptosystem.

In a further embodiment of the invention the real number α is replaced by the 2-dimensional real vector g=(g₁, g₂) in order to further enhance the security level of the proposed system.

A 2-dimensional embodiment of the system hereof works with the semi-open unit square and integer 2×2 matrices A and B of the form:

$$A = [ \begin{matrix}{a}_{0} & - {a}_{1} \\ {a}_{1} & {a}_{0}\end{matrix} ] and B = [ \begin{matrix}{b}_{0} & - {b}_{1} \\ {b}_{1} & {b}_{0}\end{matrix} ]$$

where a₀, a₁, b₀, b₁ are arbitrary integers. This structure of A and B guarantees their commutation: A·B=B·A.

Absolute values of each integer a₀, a₁, b₀, b₁ are bounded by a publicly available constant 10^{N} that may be arbitrarily big. Thus the keys created and distributed by the system hereof can be of any given in advance size.

In this embodiment the vector g=(g₁, g₂) has coordinates g₁ and g₂ which are arbitrary real numbers, that is, g is an arbitrary point of plane.

Let {x} be the fractional part of a real number x. By definition, for each real number x, the fractional part {x} is given by:
{x}=x−[x],
where [x]is the integer part of x, that is, [x]is the greatest integer that is less or equal x.

If the numbers a₀, a₁ and b₀, b₁ are integers having at most N decimal digits each (that is, |a₀|<10^{N}, |a₁|<10^{N} and |b₀|<10^{N}, |b₁|<10^{N}) and each coordinate of the vectors
{g●A}=({g₁a₀+h₂a₁}, {−g₁a₁+g₂a₀}) and {g●B}=({g₁b₀+g₂b₁},{−g₁b₁+g₂b₀})
is rounded to D+N+K decimal places after dot (where D, N, and K are natural numbers each greater than 1), then the created and distributed key, which is the vector {g●A●B}, in each of its coordinates will have K correct decimal places after the dot. These 2K correct digits serve as the encryption/decryption key of major cryptosystems.

The security of this two-dimensional embodiment is further enhanced even in comparison with the high security of the one-dimensional embodiment.

In creating geometric key establishment system in accordance with the 2-dimensional embodiment hereof, a first step is to choose publicly available parameters of the system: a real vector g=(g₁, g₂) and natural numbers D, N, K, each greater than 1, where D stand for the size of the error control buffer, N stands for the maximum number of decimal places in each secret parameter a and b, and K stands for the key length.

This embodiment of the geometric key establishment system hereof relies on the concept of (K, D)-consistent vectors. An infinite decimal fraction δ=0. d₁ d₂ d₃ . . . is said to be (K, D)-consistent if the sequence of the digits d_{K+1}, d_{K+2}, . . . d_{K+D} is neither 0, 0, . . . , 0 nor 9, 9, . . . , 9. We say that a vector (×1,x 2) is (K,D)-consistent both x₁ and x₂ are (K,D)-consistent numbers.

To implement the key creation and key distribution of this example, the first communicating party, call it Alice, chooses a pair of secret integers (a₀, a₁) each between −10^{N} and 10^{N} (i.e., each of these integers has at most N decimal places). Then Alice calculates the vector (y₁, y₂), where γ₁ is {g₁a₀+g₂a₁} rounded to D+N+K decimal places and y₂ is {−g₁a₁+g₂a₀} rounded to D+N+K decimal places; and sends so calculated vector (y₁, y₂) to the second communicating party, call it Bob. [It is assumed in this example that Alice and Bob share the publicly available parameters g=(g₁, g₂) and D, N, K.]

Simultaneously and independently Bob chooses a pair of secret integers (b₀, b₁) each between −10^{N} and 10^{N} (i.e., each of these integers has at most N decimal places). Then Bob calculates the calculates the vector (z₁, z₂) where z₁ is {g₁b₀+g₂b₁} rounded to D+N+K decimal places and z₂ is {−g₁b₁+g₂b₀} rounded to D+N+K decimal places; and sends so calculated so calculated vector (z₁, z₂) to Alice.

Upon receiving the vector (y₁, y₂) from Alice, Bob calculates the vector (k₁, k₂) by the formula:
(k₁, k₂)=({y₁b₀+y₂b₁}, {−y₁b₁+y₂b₀}).

If the vector (k₁, k₂) is (K, D)-consistent then Bob calculates the geometric key (s₁, s₂) by rounding each coordinate of (k₁, k₂) to K decimal places. Otherwise, he restarts the protocol.

Upon receiving the vector (z₁, z₂) from Bob, Alice calculates the vector (k′₁, k′₂) by the formula:
(k′₁, k′₂)=({z₁a₀+z₂a₁}, {−z₁a₁+z₂a₀}).

If the vector (k′₁, k′₂) is (K, D)-consistent then Alice calculates the geometric key (s′₁, s′₂) by rounding each coordinate of (k′₁, k′₂) to K decimal places. Otherwise, she restarts the protocol.

The mathematical argument presented below proves that the geometric key (s₁, s₂) in possession of Bob to the geometric key (s′₁, s′₂) in possession of Alice.

In those (extremely rare) cases when (k₁, k₂) is not (K, D)-consistent, the geometric key has to be redistributed because otherwise it may happen that (s₁, s₂)≠(s′₁, s′₂). In order to avoid such a situation, Alice and Bob choose new pairs of secret numbers (a′₀, a′₁) and (b′₀, b′₁) respectively (while keeping the same g=(g₁, g₂) and D, N, K) and repeat the above steps until they get a new geometric key (s₁, s₂)=(s′₁, s′₂) (provided that the new vector (k₁, k₂) is (K, D)-consistent).

The probability of the need for such redistribution is extremely low and is measured as at most 4·10^{-D}. The probability of the need for the second key distribution is measured as at most (4·10^{-D})².

The embodiment of the system hereof is based on the following mathematical argument.

Proposition. Let be P=(P₁, P₂, . . . , Pₙ), Q=(Q₁, Q₂, . . . , Qₙ) and L=(L₁, L₂, . . . , Lₙ) be n-tuples of natural numbers. Let α and β be n×n matrices with natural coefficients such that:
Q⁻¹·α≦L⁻¹, P⁻¹·β≦L⁻¹.

Then for any real vector g=(g₁, g₂, . . . ,gₙ) any n×n matrices A and B with integer coefficients such that A·B=B·A and
|Aᵢⱼ|<αᵢⱼ, |Bᵢⱼ|<βᵢⱼ
(for all i=1,2, . . . , n, j=1,2, . . . ,n) one has: either at least one coordinate of [{([{g·A}]ₚ)·B}]_{L} equals 0, or at least one coordinate of [{([{g·B}]_{Q})·A}]_{L} equals 0, or
{([{g·A}]ₚ)·B}−{([{g·B}]_{Q})·A}=θ·L⁻¹,

Proof. By definition, one has:
[{g·A}]_{P}={g·A}+θ₁·P⁻¹, [{g·B}]_{Q}={g·B}+θ₂·Q⁻¹,
where −½≦θ₁≦½ and − 1/2≦θ₂≦½. Therefore,
([{g·A}]_{P})·B=({g·A}+θ₁·P⁻¹)·B={g·A}·B+θ₁·P⁻¹·B={g·A}·B+E₁,
where E₁=θ₁·P⁻¹·B.

Similarly,
([{g·B}]_{Q})·A=({g·B}+θ₂·Q⁻¹)·A={g·B}·A+θ₂·Q⁻¹·A={g·B}·A+E₂,
where E₂=θ₂·Q⁻¹·A.

By the assumptions, one has:
|E₁|=|θ₁·P⁻¹·B|≦½·|P⁻¹·B|<½·P⁻¹·β≦½·L⁻¹
and
|E₂|=|θ₂·Q⁻¹·A|≦½·|Q⁻¹·A|<½·Q⁻¹·α≦½·L⁻¹.

In its turn, this implies that either |([{g·A}]_{P})·B| is not greater than L⁻¹ or:
{([{g·A}]_{P})·B}={{g·A}·B+E₁}={{g·A}·B}+E₁={g·A·B}+E₁,

Similarly, this implies that either |([{g·B}]_{Q})·A| is not greater than L⁻¹ or:
{([{g·B}]_{Q})·A}={{g·B}·A+E₂}={{g·B}·A}+E₂={g·B·A}+E₂.

Since A·B=B·A, one has:
{([{g·A}]_{P})·B}−{([{g·B}]_{Q})·A}=E₁−E₂=θ·L⁻¹,
where −1<θ<1.□

We say that a vector x=(x₁,x₂, . . . , xₙ) is (K, D)-consistent if:
(−c, −c, . . . , −c)≦x−[x]_{K}≦(c, c, . . . , c)
where c=½−1/(2D).

Corollary. In the notation of the Proposition, if L=D·K and one the vectors {([{g·A}]_{P})·B} and {([{g·B}]_{Q})·A} is (K, D)-consistent then
[([{g·A}]_{P})·B]_{K}=[([{g·B}]_{Q})·A]_{K}.

For the 2-dimensional embodiment of the system hereof the Corollary is applied with n=2, K=(K,K). Therefore, the Corollary guarantees that (s₁, s₂)=(s′₁, s′₂) in the protocol.

In creating a geometric key establishment system in accordance with the two-dimensional embodiment hereof (and with the following small numbers for ease of illustration), a first step is to choose publicly available parameters of the system: a vector g=(g₁, g₂) and integer parameters D, N, K greater than 1 each. Take, for example, g₁=√2, g₂=√3, N=K=8, D=2. Next, suppose that Alice chooses a pair of secret integers (a₀, a₁)=(48176925, 18034725). Alice calculates the vector
(y₁, y₂)=({g₁a₀+g₂a₁}, {−g₁a₁+g₂a₀})
each coordinate of which rounded to D+N+K=18 decimal places:

$$( {y}_{1} , {y}_{2} ) = ( \{ \sqrt{2} \cdot \text{48176925} + \sqrt{3} \cdot \text{18034725} \} , \{ - \sqrt{2} \cdot \text{18034725} + \sqrt{3} \cdot \text{48176925} \} ) = ( \{ \text{68132460.728431422183990297539596} + \text{31237060.000532620547511774721314} \} , \{ - \text{25504952.688669116604000035676723} + \text{83444881.852435233704474767836253} \} ) = ( \text{0.728964042731502072} , \text{0.163766117100474732)}$$

and sends this vector (y₁, y₂) to Bob. Suppose that at the same time Bob a pair of secret integers (b₀, b₁)=(19082792, 27045821). Alice calculates the vector
(z₁, z₂)=({g₁b₀+g₂b₁}, {−g₁b₁+g₂b₀})
each coordinate of which rounded to D+N+K=18 decimal places:

$$( {z}_{1} , {z}_{2} ) = ( \{ \sqrt{2} \cdot \text{19082792} + \sqrt{3} \cdot \text{27045821} \} , ( - \sqrt{2} \cdot \text{27045821} + \sqrt{3} \cdot \text{19082792} \} ) = ( \{ \text{26987143.25434479912512475172839} + \text{46844736.104413300451707772339473} \} , \{ - \text{38248566.863715063905876737732694} + \text{33052365.294268911065907204826118\})} = ( \text{0.358758099664220248} , 0 \text{.430553847160030467} )$$

and sends this vector (z₁, z₂) to Alice. Upon receiving the vector (y₁, y₂) from Alice, Bob calculates the vector (k₁, k) by the formula:
(k₁k₂)=({y₁b₀+y₂b₁}, {−y₁b₁+y₂b₀})
with the precision K+D=10 decimal places after dot:

$$( {k}_{1} , K ) = ( \{ \text{0.728964042731502072} \cdot \text{19082792} + {0.1637661171}_{2} 00474732 \cdot \text{27045821} \} , \{ - \text{0.728964042731502072} \cdot \text{27045821} + \text{0.163766117100474732} \cdot \text{19082792} \} ) = ( \{ \text{13910669.202924365887545024} + \text{4429189.088964478616694972} \} , \{ - \text{19715431.015152556100441112} + \text{3125114.749276002412011744} \} ) = ( \text{0.2918888445} , \text{0.7341234463)}$$

Since this vector is (K,K, D)-consistent (i.e., its first coordinate has digits 4 and 5 at 9^{th} and 10^{th} places after dot, and its second coordinate has digits 6 and 3 at 9^{th} and 10^{th} places after the dot), the vector (k₁, k₂), being rounded to the first K=8 digits of each coordinate, constitutes the geometric key in possession of Bob:
(0.29188884, 0.73412345).

Upon receiving the vector (z₁, z₂) from Bob, Alice calculates the vector (k′₁, k′₂) by the formula:
(k′₁, k′₂)=({z₁·a₀+z₂·a₁}, {−z₁·a₁+z₂·a₀})
with the precision K+D=10 decimal places after dot:

$$( {k}_{1}^{′} , {k}_{2}^{′} ) = ( \{ \text{0.358758099664220248} \cdot \text{48176925} + \text{0.430553847160030467} \cdot \text{18034725} \} . \{ - \text{0.358758099664220248} \cdot \text{48176925} \} ) = ( \{ \text{17283862.0606656640713774} + \text{7764920.231223180463966575} \} , \{ - \text{6470103.6689668045121118} + \text{20742760.403090250806373975} \} ) = ( \text{0.2918888445} , \text{0.7341234463} )$$

Since this vector is (K, D)-consistent (i.e., its first coordinate has digits 4 and 5 at 9^{th} and 10^{th} places after dot, and its second coordinate has digits 6 and 3 at 9^{th} and 10^{th} places after the dot), the vector (k′₁, k′₂), being rounded to the first K=8 digits of each coordinate, constitutes the geometric key in possession of Alice:
(0.29188884, 0.73412345).

Thus, the vector (0.29188884, 0.73412345) is the geometric key shared by Alice and Bob. This key can be used in any major symmetric cryptosystem.

The invention has been described with reference to a particular preferred embodiment, but variations within the spirit and scope of the invention will occur to those skilled in the art. For example, it will be understood that the public information g=(g₁, g₂), D, N, K of the system can be stored on any suitable media, for example a “smart card,” which can be provided with a microprocessor capable of performing arithmetic operations so that the keys can be distributed to and/or from the smart card.

1. A method of secure distribution of encryption/decryption keys among two communicating parties comprising of:
public (non-secret) selecting a natural number n;
public (non-secret) selecting a natural number k;
public (non-secret) selecting a k-tuple S=(S₁, S₂, . . . , Sₖ) of pairwise-commuting n×n matrices with integer coefficients;
private (non-public) generating the polynomial p(x₁, x₂, . . . , xₖ) in k variables x₁, x₂, . . . , xₖ and with integer coefficients by the first communicating party;
private (non-public) generating the polynomial q(x₁, x₂, . . . , xₖ) in k variables x₁, x₂, . . . , kₖ and with integer coefficients by the second communicating party;
private (non-public) generating n×n matrix A with integer coefficients by the first communicating party according to the formula:
A=p(S₁, S₂, . . . , Sₖ);
private (non-public) generating n×n matrix B with integer coefficients by the second communicating party:
B=q(S₁S₂, . . . , Sₖ),
(therefore, A·B=B·A);
public (non-secret) selecting a compact topological monoid G by both communicating parties;
public (non-secret) selecting an n-tuple g=(g₁, g₂, . . . , gₙ) of pairwise commuting elements in G by both communicating parties;
generating the n-tuple g^{A} by the first communicating party by the formula:
g^{A}=(y₁, y₂, . . . , yₙ),
where
yⱼ=g₁^{A1,j}·g₂^{A2,j}· . . . ·gₙ^{An,j}
for j=1, 2, . . . , n, where each Aᵢⱼ is a corresponding matrix coefficient of the matrix A;
generating the n-tuple g^{B} by the second communicating party by the formula:
g^{B}=(z₁, z₂, . . . , zₙ),
where
zⱼ=g₁^{B1,j}·g₂^{B2,j}· . . . ·gₙ^{Bn,j}
for j=1, 2, . . . , n, where each Bᵢⱼ is a corresponding matrix coefficient of the matrix B;
public (non-secret) transmitting the n-tuple g^{A} from the first communicating party to the second communicating party;
public (non-secret) transmitting the n-tuple g^{B} from the second communicating party to the first communicating party;
creating the shared secrete key g^{A·B} by the communicating parties: generating the n-tuple (g^{A})^{B} by the second communicating party and generating the n-tuple (g^{B})^{A} by the first communicating party (since (g^{A})^{B}=g^{A·B}=g^{B·A}=(g^{B})^{A}, both communicating parties possess this n-tuple g^{A·B}).

2. The method as defined by claim 1, wherein G is an arbitrary compact topological monoid and the polynomials p(x₁, x₂, . . . xₖ) and q(x₁, x₂, . . . , xₖ) have non-negative integer coefficients, and all the matrices S₁, S₂, . . . , Sₖ have non-negative integer matrix coefficients.

3. The method as defined by claim 1, wherein G is an arbitrary compact topological group and the polynomials p(x₁, x₂, . . . xₖ) and q(x₁, x₂, . . . , xₖ) have arbitrary integer coefficients, and all the matrices S₁, S₂, . . . Sₖ have arbitrary integer matrix coefficients.

4. The method as defined by claims 1 and 2, wherein G is an arbitrary compact topological monoid, k=1 and the n×n matrix S has non-negative integer matrix coefficients so that
A=a₀·I+a₁·S+a₂·S²+ . . . +aₙ₋₁·Sⁿ⁻¹ and B=b₀·I+b₁·S+b₂·S²+ . . . +bₙ₋₁·Sⁿ⁻¹,
where a₀, a₁, . . . , aₙ₋₁ are non-negative integers privately generated by the first communicating party and b₀, b₁, . . . , bₙ₋₁ are non-negative integers privately generated by the second communicating party, and where I is the identity n×n matrix.

5. The method as defined by claims 1 and 3, wherein G is an arbitrary compact topological group, k=1 and the n×n matrix S has arbitrary integer matrix coefficients so that
A=a₀·I+a₁·S+a₂·S²+ . . . +aₙ₋₁·Sⁿ⁻¹ and B=b₀·I+b₁·S+b₂·S²+ . . . +bₙ₋₁·Sⁿ⁻¹,
where a₀, a₁, . . . , aₙ₋₁ are arbitrary integers privately generated by the first communicating party and b₀, b₁, . . . , bₙ₋₁ are arbitrary integers privately generated by the second communicating party, and where I is the identity n×n matrix.

6. The method as defined by claims 1, 2, and 4, wherein G is an arbitrary compact topological monoid, k=1, n=2, and the 2×2 matrix S has non-negative integer matrix coefficients s₁₁, s₁₂, s₂₁, s₂₂ so that
$$A = [ \begin{matrix}{a}_{0} + {a}_{1} {s}_{11} & {a}_{1} {s}_{12} \\ {a}_{1} {s}_{21} & {a}_{0} + {a}_{1} {s}_{22}\end{matrix} ] and B = [ \begin{matrix}{b}_{0} + {b}_{1} {s}_{11} & {b}_{1} {s}_{12} \\ {b}_{1} {s}_{21} & {b}_{0} + {b}_{1} {s}_{22}\end{matrix} ]$$
where a₀, a₁ are non-negative integers privately generated by the first communicating party and b₀, b₁ are non-negative integers privately generated by the second communicating party. Therefore,
$$\begin{matrix}A \cdot B = B \cdot A \\ = [ \begin{matrix}{a}_{0} {b}_{0} + ( {a}_{0} {b}_{1} + {b}_{0} {a}_{1} + {a}_{1} {b}_{1} {s}_{11} ) {s}_{11} + {a}_{1} {b}_{1} {s}_{12} {s}_{21} & ( {a}_{0} {b}_{1} + {b}_{0} {a}_{1} + {a}_{1} {b}_{1} {s}_{11} + {a}_{1} {b}_{1} {s}_{22} ) {s}_{12} \\ ( {a}_{0} {b}_{1} + {b}_{0} {a}_{1} + {a}_{1} {b}_{1} {s}_{11} + {a}_{1} {b}_{1} {s}_{22} ) {s}_{21} & {a}_{0} {b}_{0} + ( {a}_{0} {b}_{1} + {b}_{0} {a}_{1} + {a}_{1} {b}_{1} {s}_{22} ) {s}_{22} + {a}_{1} {b}_{1} {s}_{12} {s}_{21}\end{matrix} ]\end{matrix}$$

7. The method as defined by claims 1, 3, and 5, wherein G is an arbitrary compact topological group, k=1, n=2, and the 2×2 matrix S has arbitrary integer matrix coefficients s₁₁, s₁₂, s₂₁, s₂₂ so that
$$A = [ \begin{matrix}{a}_{0} + {a}_{1} {s}_{11} & {a}_{1} {s}_{12} \\ {a}_{1} {s}_{21} & {a}_{0} + {a}_{1} {s}_{22}\end{matrix} ] and B = [ \begin{matrix}{b}_{0} + {b}_{1} {s}_{11} & {b}_{1} {s}_{12} \\ {b}_{1} {s}_{21} & {b}_{0} + {b}_{1} {s}_{22}\end{matrix} ]$$
where a₀, a₁ are arbitrary integers privately generated by the first communicating party and b₀, b₁ are arbitrary integers privately generated by the second communicating party. Therefore,
$$A \cdot B = B \cdot A = [ \begin{matrix}{a}_{0} {b}_{0} + ( {a}_{0} {b}_{1} + {b}_{0} {a}_{1} + {a}_{1} {b}_{1} {s}_{11} ) {s}_{11} + {a}_{1} {b}_{1} {s}_{12} {s}_{21} & ( {a}_{0} {b}_{1} + {b}_{0} {a}_{1} + {a}_{1} {b}_{1} {s}_{11} + {a}_{1} {b}_{1} {s}_{22} ) {s}_{12} \\ ( {a}_{0} {b}_{1} + {b}_{0} {a}_{1} + {a}_{1} {b}_{1} {s}_{11} + {a}_{1} {b}_{1} {s}_{22} ) {s}_{21} & {a}_{0} {b}_{0} + ( {a}_{0} {b}_{1} + {b}_{0} {a}_{1} + {a}_{1} {b}_{1} {s}_{22} ) {s}_{22} + {a}_{1} {b}_{1} {s}_{12} {s}_{21}\end{matrix} ]$$

8. The method as defined by claims 1 and 2, wherein G is an arbitrary compact topological monoid, k=2 and the n×n matrices S₁ and S₂ have non-negative integer matrix coefficients and satisfy S₁·S₂=S₂·S₁ so that
A=Σⁿ⁻¹_{i,j=0}a_{i,j}·S₁ⁱ·S₂^{j} and B=Σⁿ⁻¹_{i,j=0}b_{i,j}·S₁ⁱ·S₂^{j},
where all a_{i,j}, i=0, 1, . . . , n−1, and j=0, 1, . . . , n−1, are non-negative integers privately generated by the first communicating party and all b_{i,j}, i=0, 1, . . . , n−1, and j=0, 1, . . . , n−1, are non-negative integers privately generated by the second communicating party, and where I is the identity n×n matrix.

9. The method as defined by claims 1 and 3, wherein G is an arbitrary compact topological group, k=2 and the n×n matrices S₁ and S₂ have arbitrary integer matrix coefficients and satisfy S₁·S₂=S₂·S₁ so that
A=Σⁿ⁻¹_{i,j=0}a_{i,j}·S₁ⁱ·S₂^{j} and B=Σⁿ⁻¹_{i,j=0}b_{i,j}·S₁ⁱ·S₂^{j},
where all a_{i,j}, i=0, 1, . . . , n−1, and j=0, 1, . . . , n−1, are arbitrary integers privately generated by the first communicating party and all b_{i,j}, i=0, 1, . . . , n−1, and j=0, 1, . . . , n−1, are arbitrary integers privately generated by the second communicating party, and where I is the identity n×n matrix.

10. The method as defined by claim 1, wherein n=1 and G is any compact topological monoid and the said 1×1 matrices A and B are any non-negative integers.

11. The method as defined by claim 1, wherein n=1 and G is any compact topological group and the said 1×1 matrices A and B are arbitrary integers.

12. The method as defined by claims 1, 2, 4, 6, and 8 wherein G is any commutative compact topological monoid.

13. The method as defined by claims 1, 3, 5, 7, and 9, wherein G is any commutative compact topological group.

14. The method as defined by claim 11, wherein n=1 and G is any connected compact Lie group.

15. The method as defined by claim 11, wherein n=1 and said G is a connected closed subgroup of the orthogonal group O(V), where V is a Euclidean vector space.

16. The method as defined by claim 11, wherein n=1 and said G is a connected closed subgroup of the unitary group U(W), where W is a Hermitian vector space.

17. The method as defined by claim 15, wherein the group G is the special orthogonal group SO(V), that is, G is the connected component of the identity in the orthogonal group O(V).

18. The method as defined by claim 16, wherein the group G is the unitary group U(W).

19. The method as defined by claim 15, wherein the set V is a Euclidean vector space of dimension m, where m is an integer greater than 1.

20. The method as defined by claim 16, wherein the set W is a Hermitian vector space of dimension m, where m is an integer greater than 0.

21. The method as defined by claim 19, wherein said V is the real vector space R^{m} with the standard Euclidean dot product:
x·y=x₁y₁+x₂y₂+ . . . +xₘyₘ
for any vectors x=[x₁, x₂, . . . , xₘ] and y=[y₁, y₂, . . . , yₘ]of R^{m}.

22. The method as defined by claim 16, wherein said W is the complex vector space C n with the standard Hermitian dot product:
x·y*=x₁y₁*+x₂y₂*+ . . . +xₘyₘ*
for any vectors x=[x₁, x₂, . . . , xₘ] and y=[y₁, y₂, . . . , yₘ] of C^{m}, where yᵢ* is the complex conjugate number of the complex number yᵢ.

23. The method as defined by claims 17 and 21, wherein the group G is the group SOₘ of special orthogonal m×m matrices, that is, SOₘ is the set of all real m×m matrices M such that the determinant of M is 1 and M·M^{T}=I, where M^{T} is the transposed matrix of M and I is the identity m×m matrix.

24. The method as defined by claims 18 and 22, wherein the group G is the group Uₘ of unitary m×m matrices, that is, Uₘ is the set of all complex m×m matrices M such that M·M*=I, where M* is the transposed complex conjugate matrix of M and I is the identity m×m matrix.

25. The method as defined by claims 23 and 24, wherein the group G is any of two isomorphic groups SO₂ or U₁.

26. The method as defined by claims 13 and 25, wherein the group G is a torus of dimension m, that is, G is direct product of m copies of the group U₁.

27. The method of claim 25, wherein as the group G is further defined as the semi-open interval [0, 1) of real numbers that includes 0 but does not include 1, where the group operation “*” is the fractional part of the sum:
g*h={g+y}
for any real g and h in the semi-open interval [0, 1), where {Z} stands for the fractional part of a real number z.

28. The method as defined by the claims 1 and 27, wherein the said n-tuple g is given by:
g=(g₁, g₂, . . . , gₙ),
where g₁, g₂, . . . , gₙ are real numbers in the semi-open interval [0,1); and for a given integer n×n matrix A=(Aᵢⱼ) the power g^{A} is given by:
g^{A}=(y₁, y₂, . . . , yₙ),
where yⱼ={g₁A_{1,j}+g₂A_{2,j}+ . . . +gₙA_{n,j}} for j=1, 2, . . . , n; and for a given integer n×n matrix B=(Bᵢⱼ) the power g^{B} is given by:
g^{B}=(z₁, z₂, . . . , zₙ),
where zⱼ={g₁B_{1,j}+g₂B_{2,j}+ . . . +gₙB_{n,j}} for j=1, 2, . . . , n.

29. The method as defined by the claims 1, 7, 27, and 28, wherein n=2, g=(g₁, g₂), the 2×2 matrices A and B are given by:
$$A = [ \begin{matrix}{a}_{0} + {a}_{1} {s}_{11} & {a}_{1} {s}_{12} \\ {a}_{1} {s}_{21} & {a}_{0} + {a}_{1} {s}_{22}\end{matrix} ]$$
$$and$$
$$B = [ \begin{matrix}{b}_{0} + {b}_{1} {s}_{11} & {b}_{1} {s}_{12} \\ {b}_{1} {s}_{21} & {b}_{0} + {b}_{1} {s}_{22}\end{matrix} ]$$
and the powers g^{A} and g^{B} are given by:
g^{A}(y₁, y₂),
where
y₁={g₁(a₀+a₁s₁₁)+g₂(a₁s₂₁)} and y₂={g₁(a₁s₁₂)+g₂(a₀+a₁s₂₂)};
and
g^{B}=(z₁, z₂),
where
z₁={g₁(b₀+b₁s₁₁)+g₂(b₁s₂₁)} and z₂={g₁(b₁s₁₂)+g₂(b₀+b₁s₂₂)};
Therefore, the shared key g^{A●B}=g^{B●A}=(k₁, k₂) is given by:
$${k}_{1} = \{ ( {a}_{0} {b}_{0} + ( {a}_{0} {b}_{1} + {b}_{0} {a}_{1} + {a}_{1} {b}_{1} {s}_{11} ) {s}_{11} + {a}_{1} {b}_{1} {s}_{12} {s}_{21} ) {g}_{1} + ( {a}_{0} {b}_{1} + {b}_{0} {a}_{1} + {a}_{1} {b}_{1} {s}_{11} + {a}_{1} {b}_{1} {s}_{22} ) {s}_{21} {g}_{2} \} , \\ {k}_{2} = \{ ( {a}_{0} {b}_{1} + {b}_{0} {a}_{1} + {a}_{1} {b}_{1} {s}_{11} + {a}_{1} {b}_{1} {s}_{22} ) {s}_{12} {g}_{1} + ( {a}_{0} {b}_{0} + ( {a}_{0} {b}_{1} + {ba}_{1} + {a}_{1} {b}_{1} {s}_{22} ) {s}_{22} + {a}_{1} {b}_{1} {s}_{12} {s}_{21} ) {g}_{2} \}$$

30. Method as defined by the claims 1, 7, 27, 28, and 29, wherein n=2, g=(g₁, g₂), and the said matrix S is given by
$$S = [ \begin{matrix}0 & - 1 \\ 1 & 0\end{matrix} ]$$
therefore:
the 2×2 matrices A and B are given by:
$$A = [ \begin{matrix}{a}_{0} & - {a}_{1} \\ {a}_{1} & {a}_{0}\end{matrix} ]$$
$$and$$
$$B = [ \begin{matrix}{b}_{0} & - {b}_{1} \\ {b}_{1} & {b}_{0}\end{matrix} ]$$
the powers g^{A} and g^{B} are given by:
g^{A}=(y₁, y₂),
where
y₁={g₁a₀+g₂a₁} and y₂={−g₁a₁+g₂a₀}; and
g^{B}=(z₁, z₂),
where
z₁={g₁b₀+g₂b₁} and z₂={−g₁b₁+g₂b₀};
Therefore, the shared key g^{A·B}=g^{B·A}=(k₁, k₂) is given by:
k₁={(a₀b₀−a₁b₁)g₁+(a₀b₁+b₀a₁)g₂},
k₂={−(a₀b₁+b₀a₁)g₁+(a₀b₀−a₁b₁)g₂}.

31. The method as defined by the claim 27, wherein for each natural number P, each element g of the group G is rounded to a rational element [g]_{P} of the group G according to the formula:[g]_{P}=(Round(gP))/P
if Round(gP)<P, and
[g]_{P}=0
if Round(gP)=P, where Round(z) stands for the standard rounding of a real number z to the closest integer.

32. The method as defined by the claims 27 and 31, wherein for each n-tuple P=(P₁, P₂, . . . , Pₙ) of natural numbers, each n-tuple g=(g₁, g₂, . . . , gₙ) of elements of the group G is rounded to a rational n-tuple [g]_{P} according to the formula:
[g]_{P}=([g₁]_{P1}, [g₂]_{P2}, . . . , [gₙ]_{Pn}).

33. A method of secure distribution of encryption/decryption keys among two communicating parties comprising of:
public (non-secret) selecting a natural number n and k as in claim 1;
public (non-secret) selecting a k-tuple S═(S₁, S₂, . . . , Sₖ) of pairwise-commuting n×n matrices with integer coefficients as in claim 1;
public (non-secret) selecting n-tuples natural numbers P=(P₁, P₂, . . . , Pₙ), Q=(Q₁, Q₂, . . . Qₙ), and K=(K₁, K₂, . . . , Kₙ);
public (non-secret) selecting a natural number D>1;
public (non-secret) selecting the commutative compact topological group G as in claim 27;
public (non-secret) selecting an n-tuple g=(g₁, g₂, . . . , gₙ) elements in G as in claims 28, 29, 30, 31 and 32;
private (non-public) generating the polynomial p(x₁, x₂, . . . , xₖ) in k variables x₁, x₂, . . . , xₖ and with integer coefficients by the first communicating party as in claim 1;
private (non-public) generating the polynomial q(x₁, x₂, . . . , xₖ) in k variables x₁, x₂, . . . , xₖ and with integer coefficients by the second communicating party as in claim 1;
private (non-public) generating n×n matrix A with integer coefficients by the first communicating party as in claim 1;
private (non-public) generating n×n matrix B with integer coefficients by the first communicating party as in claim 1;
generating the n-tuple g^{A} by the first communicating party as in claim 1;
generating the P-rounded n-tuple [g^{A}]_{P} by the first communicating party as in claim 32; generating the n-tuple g^{B} by the second communicating party as in claim 1;
generating the Q-rounded n-tuple [g^{B}]_{Q} by the second communicating party as in claim 32;
public (non-secret) transmitting the n-tuple [g^{A}]_{P} from the first communicating party to the second communicating party;
public (non-secret) transmitting the n-tuple [g^{B}]_{Q} from the second communicating party to the first communicating party;
creating the shared secrete key by the communicating parties: generating the n-tuple [([g^{A}]_{P})^{B}]_{K} by the second communicating party and generating the n-tuple [([g^{B}]_{Q})]_{K} by the first communicating party.

34. The method as defined by the claims 28, 29, 30, 31, 32, and 33, wherein at least one coordinate of the said vector g=(g₁, g₂, . . . , gₙ) is an irrational number.

35. The method as defined by the claims 28, 29, 30, 31, 32, and 33, wherein each coordinate gᵢ of the said vector g=(g₁, g₂, . . . , gₙ) is a rational number of the form
gᵢ=Mᵢ/Nᵢ,
where 0≦Mᵢ≦Nᵢ.

36. The method as defined by the claim 33, wherein the n-tuples of natural numbers P=(P₁, P₂, . . . , Pₙ),Q=(Q₁, Q₂, . . . , Qₙ), and K=(K₁, K₂, . . . , Kₙ) and the natural number D satisfy the following compatibility conditions:
Q⁻¹·α≦(D·K)⁻¹, P⁻¹·β≦(D·K)⁻¹,
where α and β are arbitrary public (non-secret) n×n matrices with natural coefficients αᵢⱼ and βᵢⱼ respectively such that:

|Aᵢⱼ|<αᵢⱼ, |Bᵢⱼ|<βᵢⱼ
for all i=1,2, . . . , n, j=1,2, . . . ,n; and P⁻¹=(1/P₁, 1/P₂, . . . , 1/Pₙ), Q⁻¹=(1/Q₁, 1/Q₂, . . . , 1/Qₙ), (D·K)⁻¹=(1/(DK₁), 1/(DK₂), . . . , 1/(DKₙ)), and the vector inequality
(y₁, y₂, . . . , yₙ)≦(z₁, z₂, . . . , zₙ)
is equivalent to n scalar inequalities:
y₁≦z₁, y₂≦z₂, . . . , yₙ≦zₙ. The compatibility conditions guarantee that either at least one coordinate of [([g^{A}]_{P})^{B}]_{D·K} equals 0, or at least one coordinate of [([g^{B}]_{Q})^{A}]_{D·K} equals 0, or
([g^{A}]_{P})^{B}−([g^{B}]_{Q})^{A}=θ·(D·K)⁻¹,
where −½<θ<½.

37. The method as defined by the claim 33, wherein a vector x=(x₁,x₂, . . . , xₙ) is defined to be (K, D)-consistent if:
(−c, −c, . . . , −c)≦x−[x]_{K}≦(c, c, . . . , c),
where c=½−1/(2D).

38. The method as defined by the claims 33, 36, and 37 wherein both n-tuples ([g^{A}]_{P})^{B} and ([g^{B}]_{Q})^{A} are (K, D)-consistent, which guarantees the equality of the shared keys:
[([g^{A}]_{P})^{B}]_{K}=[([g^{B}]_{Q})^{A}]_{K}.

39. The method as defined by the claims 30, 33, 35, 36, and 37, wherein
g=(M₁/N₁, M₂/N₂),
where θ≦M₁<N₁, 0≦M₁<N₂; and the 2×2 matrices A and B are given by:
$$A = [ \begin{matrix}{a}_{0} & - {a}_{1} \\ {a}_{1} & {a}_{0}\end{matrix} ]$$
$$and$$
$$B = [ \begin{matrix}{b}_{0} & - {b}_{1} \\ {b}_{1} & {b}_{0}\end{matrix} ]$$
where |a₀|<α₀, |a₁|<α₁, |b₀|<β₀, |b₁|<β₁, where α₀, α₁, β₀, β₁ are natural numbers each of which does not exceed N₁·N₂; and:
α₀/Q₁+α₁/Q₂≦1/(DK₁), α₁/Q₁+α₀/Q₂≦(1/DK₂), β₀/P₁+β₁/P₂≦1/(DK₁), β₁/P₁+α₀/P₂≦1/(DK₂).

40. The method as defined by the claims 36, 37, 38, and 39, wherein each coordinate K of the said n-tuple K=(K₁, K₂, . . . Kₙ) is given by the formula:
Kᵢ=r^{Ci}
for i=1,2, . . . , n, where r is a natural number, and C1, C2, . . . , Cn are non-negative integers.

41. The method as defined by the claims 36, 37, 38, 39, and 40, wherein each i-th coordinate of the shared key [([g^{A}]_{P})^{B}]=[([g^{B}]_{Q})^{A}]_{K} is presented as a rational r-ary number having at most Ci r-ary digits after the dot.
